(19) United States
(12) Patent Application Publication
(10) Pub. No.: US 2005/0270003 A1
(43) Pub. Date: Dec. 8, 2005

(54) Modulated reference voltage control for current mode switching regulators

(76) Inventors: Brian H. Floyd, Sunnyvale, CA (US); John Sung Ko So, Fremont, CA (US)

Correspondence Address: ADVANCED ANALOGIC TECHNOLOGIES, 830 EAST ARQUES AVE, SUNNYVALE, CA, 94085, US

(21) Appl. No.: 10/861,834

(22) Filed: Jun. 5, 2004

(51) Int. Cl. G05F 1/40

(52) U.S. Cl. 323/282

(57) ABSTRACT

A method for controlling a switching power regulator uses a function of two voltages to dynamically adjust the regulator's duty cycle. The first voltage VFB corresponds to the output current of the regulator. The second voltage is an independently generated modulated reference voltage VREF. A clock signal causes the regulator to enter a charging phase. That phase is maintained until VREF no longer exceeds VFB. At that point, a discharge phase is initiated. Selecting an appropriate waveform for VREF yields a regulator with a well behaved output without the need for inner and outer control loops. This enhances transient response and low power efficiency.

### TECHNICAL FIELD OF THE INVENTION

The present invention relates generally to switching power supplies. More particularly, the present invention relates to methods for producing high efficiency switching regulators that provide fast response to transient load variations.

### BACKGROUND OF THE INVENTION

Extending battery life is one of the most important tasks faced by designers of portable electronic systems. This is particularly true for consumer electronics, such as cellular phones, digital cameras, portable computers and other handheld equipment. Designers of these products are faced with a continual need to reduce package size (and battery size) while increasing battery life to match or exceed competitive products.

To maximize battery life, it is necessary to optimize the performance of a wide range of different electronic components. Among the most important of these components are voltage regulators. In portable electronic systems, these devices are used to perform a range of power handling tasks including increasing, decreasing and inverting voltages. Each increase, decrease or inversion has an associated efficiency and represents an opportunity to extend battery life.

Switching regulators are some of the most efficient and widely used voltage regulator types. FIG. 1A shows an example of a switching regulator that is configured to increase the voltage available from a power source (a boost regulator). The boost regulator has two operational phases. During the first phase, known as the charging phase, the switch is closed and current flows from the power source through the inductor. This causes energy to be stored by the inductor in the form of a magnetic field. During the second phase, known as the discharge phase, the switch is opened. With the switch opened, the current continues to flow from the inductor as the magnetic field collapses. The switch is repeatedly opened and closed to create a train of charge and discharge phases, powering the load (represented by a resistor in this case) with a series of pulses. In addition to the boost regulator just described, switching regulators may also be used to decrease voltage. Converters of this type are known as buck converters and generally resemble the idealized example shown in FIG. 1B. Alternately, switching regulators can also be used to perform voltage inversion. An example of a regulator of this type (known as a buck-boost regulator) is shown in FIG. 1C.

The switching regulators shown in FIGS. 1A through 1C all utilize the alternating charge-discharge sequence. In general, this can be performed using either pulse-width-modulation (PWM) or pulse-frequency-modulation (PFM). PWM regulators are switched at a fixed frequency with a variable pulse width. PFM regulators, on the other hand are switched at a fixed pulse width and a variable pulse frequency. Of the two, PWM designs dominate in portable applications. This is largely because PFM regulators operate over a range of frequencies, creating a spectrum of electromagnetic noise that may be difficult to effectively control.

Both PWM and PFM regulators use feedback networks to their control their charge-discharge sequences. For PWM regulators, the feedback network controls pulse length. In PFM regulators, pulse frequency is controlled. A number of different implementations are available for feedback networks of this type. FIG. 2 shows an example of a PWM buck-type regulator configured to use a specific type of feedback network known as current mode control. For this example, a MOSFET along with an inductor, capacitor and diode for the basic buck-type network first shown in FIG. 1B. The output of a clock is passed through a reset-dominant latch to control the MOSFET. The clock produces the basic PWM pulse train with the latch controlling the width of each pulse.

Two feedback loops control operation of the latch. The first or inner loop monitors current passing through the inductor creating a current sense voltage. The second or outer loop monitors the voltage present at the load being driven (or actually, a proportion of the voltage derived using a shunt-series divider). The outer loop compares that voltage to a predetermined reference voltage to create an error voltage. The error voltage, combined with slope-compensation, sets the threshold of a comparator whose other input is connected to the inner loop. The output of the comparator drives the latch. On a cycle-by-cycle basis, the latch holds the MOSFET on until the current sense voltage exceeds the threshold set by the error voltage. At that point, the latch is reset turning the MOSFET off. Both the error voltage and the current sense voltage determine how long the MOSFET remains active during any given clock cycle.

The two-loop configuration shown in FIG. 2 is an example of peak current mode control of a PWM switching regulator. Compared to other methodologies (such as voltage mode control), current mode control tends to provide more rapid transient response (i.e., response to changes in input voltage). Current mode control also provides other advantages such as the ability to combine multiple regulators in parallel where the output of a single regulator is insufficient.

These advantages, however, come at the expense of two-loops, one of which must be optimized for stability and transient response. Therefore, there is a need for simpler single-loop switching regulators that retain the advantages of current mode regulators and operate at constant frequency. This need is particularly important for applications that cannot tolerate the noise associated with PFM based regulators.

### SUMMARY OF THE INVENTION

The present invention includes a method for current mode control of switching regulators. For a representative implementation, a switching regulator (such as a buck, boost or buck-boost regulator) operates under control of a MOSFET or other switching device. A clock signal is supplied to the MOSFET via a latch. The clock signal is the basic PWM pulse train with the latch controlling the width of each pulse.

A comparator drives the latch. The comparator receives a voltage VFB that corresponds to the output current of the switching regulator. The comparator also receives an externally generated, modulated reference voltage. The output of the comparator resets the latch whenever the voltage VREF is less than the voltage VFB. The overall result is that the duty cycle of the MOSFET is controlled as a function of VFB and the modulated reference signal VREF. Selecting an appropriate waveform for VREF yields a regulator with a well behaved output without the need for inner and outer control loops. This enhances transient response and low power efficiency.

### BRIEF DESCRIPTION OF THE DRAWINGS

FIGS. 1A through 1C are block diagrams of prior art boost, buck, and buck boost switching power regulators.

FIG. 2 is a block diagram of a prior art buck switching power regulator using current mode control.

FIG. 3 is a block diagram of a buck switching power regulator using current mode control as provided by the present invention.

FIG. 4 is a diagram showing simulated IO, VO, VFB and VREF for the switching power regulator of FIG. 3.

FIG. 5 is a diagram showing simulated VO for the switching power regulator of FIG. 3 where VREF is implemented as a fixed voltage.

FIG. 6A is a diagram showing an empirically derived IO waveform for the switching power regulator of FIG. 3.

FIG. 6B is a diagram showing an empirically derived VREF waveform for the switching power regulator of FIG. 3.

FIG. 7 shows the load-transient response (both voltage and current) of the switching power regulator of FIG. 3.

FIG. 8 shows the load-transient response (both voltage and current) of a prior art switching power regulator.

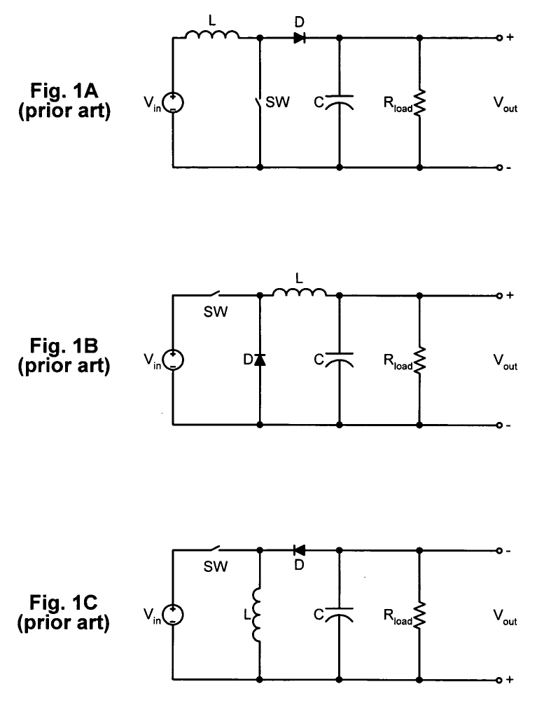

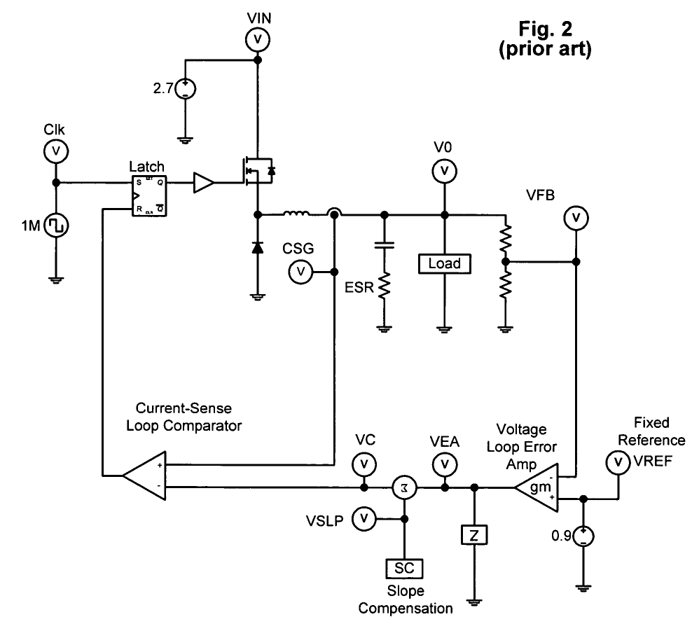

### DETAILED DESCRIPTION OF THE PREFERRED EMBODIMENTS

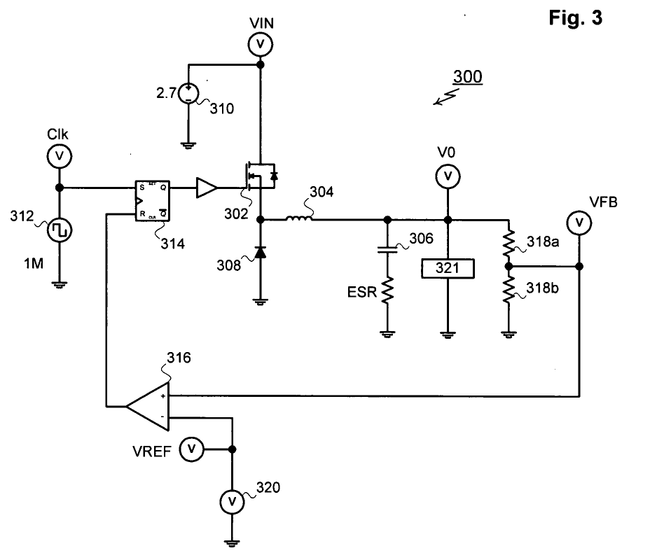

The present invention includes a method for current mode control of switching regulators. To illustrate, FIG. 3 shows a buck-type switching regulator 300 configured to use the current mode control method. Regulator 300 includes a basic buck-type network composed of a MOSFET 302 along with an inductor 304, capacitor 306 (shown in combination with its equivalent series resistance, ESR) and diode 308. The input of the buck-type network is a voltage source 310 and the output is connected to power a representative load 321.

The output of a clock 312 is connected to the set input of a reset-dominant S-R latch 314 that is connected, in turn to control MOSFET 302. Clock 312 produces a basic PWM pulse train to control MOSFET 302. Latch 316 sets the width of each pulse in the pulse train to control the duty cycle of MOSFET 302 and the buck-type network.

A comparator 316 is connected to the R input of latch 314. Comparator 316 has two inputs and is preferably of the high speed single loop type. The first input is connected to monitor a voltage VFB. A shunt-series divider composed of resistors 318a and 318b derives VFB from the output voltage (VO) of the buck-type network. The second input to comparator 316 is connected to monitor a reference voltage VREF 320.

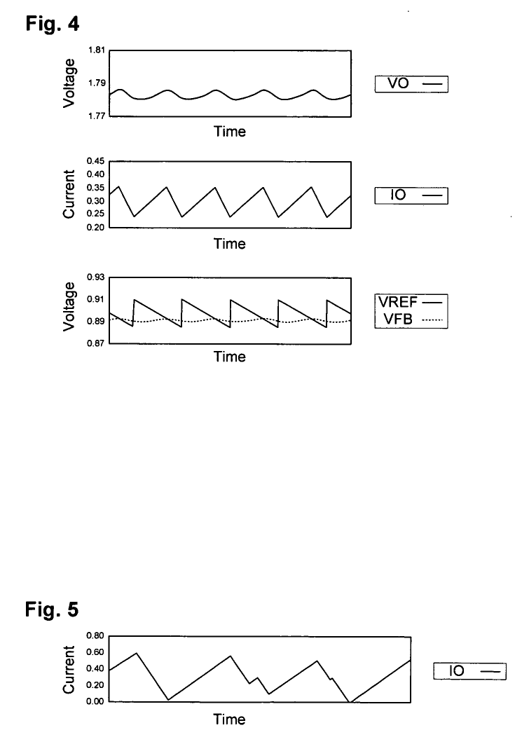

FIG. 4 shows waveforms for IO, VO, VFB and VREF obtained by simulation of for steady-state operation of switching regulator 300. As shown, both IO and VO are well formed correctly conditioned PWM outputs. This indicates that comparator 316 is correctly controlling latch 314. That indicates, in turn, that the combination of VFB and VREF provides an effective control mechanism for switching regulator 300. As shown in FIG. 4, VFB corresponds to IO. In fact, the ripple component of VFB is attributable to the ESR of capacitor 306 and corresponds to the current passing through inductor 304. VREF is generated to have a time varying voltage. The particular waveform chosen for VREF, along with the current sense voltage VO creates the well formed PWM outputs IO and VO.

For comparison, FIG. 5 shows the VO output of switching regulator 300 (also obtained by simulation) for an implementation where VREF is held constant (i.e., has no time varying or ripple quality). As is clearly shown, VO is not well formed, and the operation of switching regulator 300 is unstable.

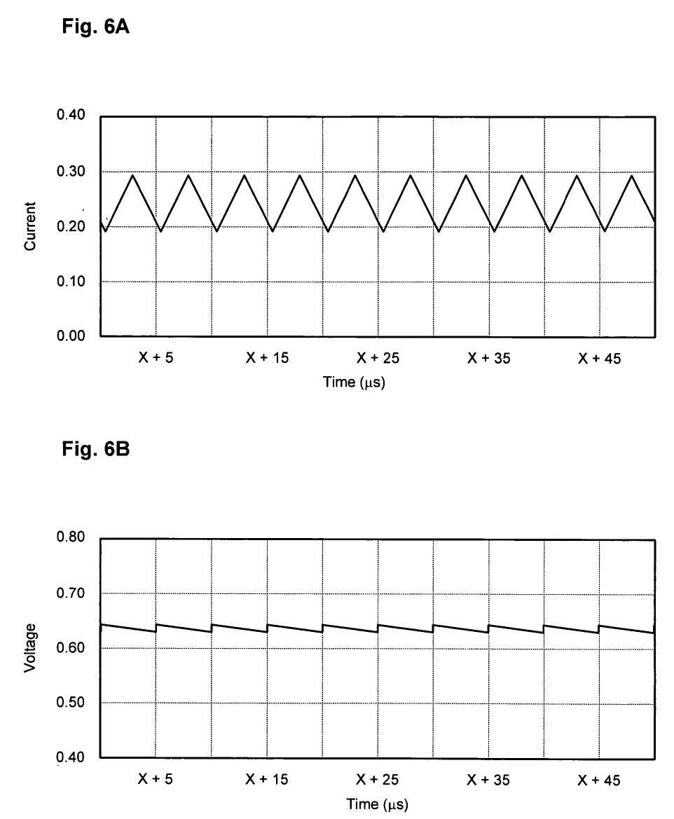

FIGS. 6A and 6B show a second set of waveforms for waveforms for IO and VREF. Unlike the waveforms discussed previously, the waveforms of FIGS. 6A and 6B were obtained empirically (and not by simulation). For this particular example, the ramp voltage VREF is given by the linear equation:

$$VREF = {V}_{fixed} - \frac{ⅆ v}{ⅆ t} * time$$

clock 312 was configured to operate at 1 Mhz, inductor 304 had a value of 4.7 μH, capacitor 306 had a value of 4.7° F. and ESR was 0.1 ohm. Once again, it should be noted that the output 10 is well behaved, indicating that switching regulator 300 is functioning correctly.

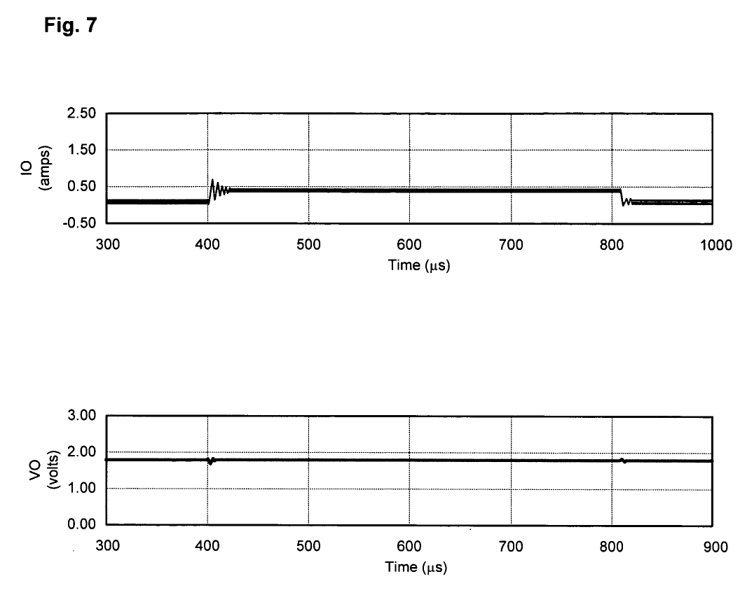

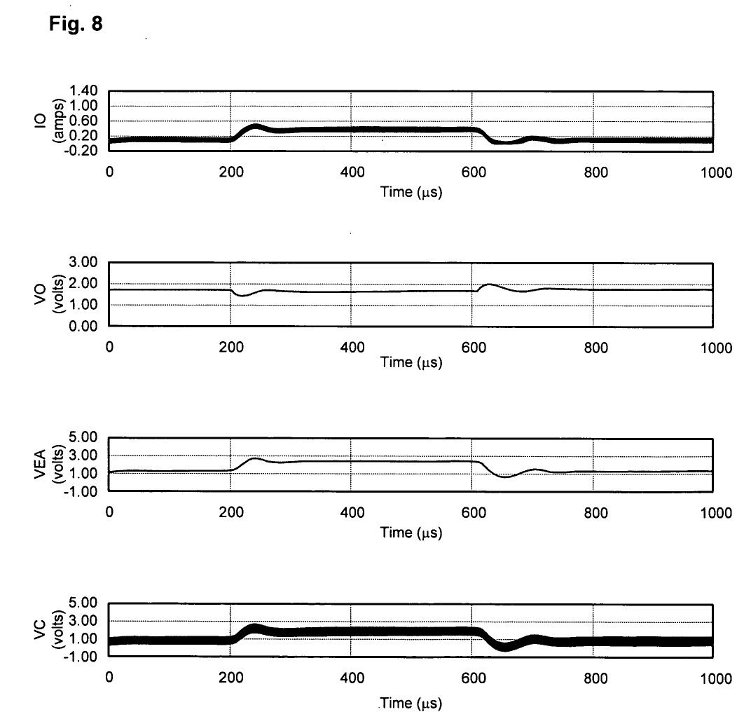

In comparison to prior art devices that use a fixed reference voltage (such as the switching regulator of FIG. 2) switching regulator 300 uses only a single control loop. By reducing the number of control loops (and eliminating the associated error amplifier) load-transient response is enhanced. This is illustrated by comparing the waveforms of FIGS. 7 and 8. In FIG. 7, the load-transient response of switching regulator 300 is shown. FIG. 8, on the other hand, shows the same waveforms produced by a prior art switching regulator. As shown in those figures, the load-transient response for switching regulator 300 is significantly better. Use of a single control loop also improved low power operation, especially in the quiescent state.

There are other important distinctions between prior art devices and the modulated-reference architecture exemplified by switching regulator 300. First, the modulated-reference architecture can be designed for stability with a small ripple. Thus, small ESR (<50 mohm) is acceptable. In addition, because the ripple signal is not equivalent to the traditional peak-current-mode architecture, we observe that the signal is required for duty cycles less than 50%. In other words, the rules of traditional slope compensation must be modified for the new architecture.

In general, it should be appreciated that the particular components chosen for switching regulator 300 are intended to be representative. A vast selection of similar components may be used without departing from the basic current mode control method. It should also be appreciated that the use of a buck type network is also representative. The current mode control method is specifically intended to be used in combination with buck, boost and buck-boost switching regulators.

1. A switching regulator producing a pulse width modulated (PWM) output, the switching regulator comprising:
a first circuit configured to generate a clock signal;
a second circuit configured to generate a modulated reference voltage; and
a third circuit configured to regulate the duty cycle of the clock signal by comparing a signal proportional to the output current of the regulator to the modulated reference voltage.

2. A switching regulator as recited in claim 1 in which the modulated reference voltage includes a DC component combined with a ramp signal.

3. A switching regulator as recited in claim 1 in which the regulator is configured to operate as one of the following types: buck, boost or buck-boost.

4. A switching regulator as recited in claim 1 in which the signal proportional to the output current of the regulator is obtained by monitoring the ripple voltage associated with a capacitor connected to be parallel to a load driven by the regulator output.

5. A switching regulator as recited in claim 1 in which the third circuit includes a comparator for comparing the signal proportional to the output current of the regulator to the modulated reference voltage.

6. A method for current mode control of a switching regulator, the method comprising:
generating a clock signal;
generate a modulated reference voltage; and
regulating the duty cycle of the clock signal by comparing a signal proportional to the output current of the regulator to the modulated reference voltage.

7. A method as recited in claim 6 in which the modulated reference voltage includes a DC component combined with a ramp signal.

8. A method as recited in claim 6 in which the regulator is configured to operate as one of the following types: buck, boost or buck-boost.

9. A method recited in claim 6 in which the signal proportional to the output current of the regulator is obtained by monitoring the ripple voltage associated with a capacitor connected to be parallel to a load driven by the regulator output.

10. A method as recited in claim 6 in which a comparator is used to compare the signal proportional to the output current of the regulator to the modulated reference voltage.

11. A switching regulator producing a pulse width modulated (PWM) output, the switching regulator configured to regulate the duty cycle of the PWM output using a single feedback loop that compares a signal proportional to the output current of the regulator to a modulated reference voltage.

12. A switching regulator as recited in claim 11 in which the modulated reference voltage includes a DC component combined with a ramp signal.

13. A switching regulator as recited in claim 11 in which the regulator is configured to operate as one of the following types: buck, boost or buck-boost.

14. A switching regulator as recited in claim 11 in which the signal proportional to the output current of the regulator is obtained by monitoring the ripple voltage associated with a capacitor connected to be parallel to a load driven by the regulator output.

15. A method for controlling a switching power regulator, the method comprising:
configuring the voltage regulator to operate in a first phase;
deriving a voltage VFB proportional to the output current of the regulator;
generating a modulated reference voltage VREF; and
configuring the voltage regulator to operate in a second phase when the voltage VFB is greater than the reference voltage VREF.

16. A method as recited in claim 15 in which the voltage VREF includes a DC component combined with a ramp signal.

17. A method as recited in claim 15 in which the regulator is configured to operate as one of the following types: buck, boost or buck-boost.

18. A method as recited in claim 15 in which VFB is obtained by monitoring the ripple voltage associated with a capacitor connected to be parallel to a load driven by the regulator output.
